(19) United States
(12) Patent Application Publication
(10) Pub. No.: US 2021/0129487 A1
(43) Pub. Date: May 6, 2021

(54) RECYCLABLE LAMINATE

(71) Applicants: Chen-Cheng HUANG, Taipei City (TW); Pao-Hao HUANG, Taipei City (TW); Pao-Han HUANG, Taipei City (TW)

(72) Inventors: Chen-Cheng HUANG, Taipei City (TW); Pao-Hao HUANG, Taipei City (TW); Pao-Han HUANG, Taipei City (TW)

(21) Appl. No.: 17/083,047

(22) Filed: Oct. 28, 2020

(30) Foreign Application Priority Data
Nov. 4, 2019 (TW) 108139939

(51) Int. Cl. B32B 7/05; B32B 5/02; B32B 5/26

(52) U.S. Cl. CPC B32B 7/05; B32B 5/024; B32B 2307/7265; B32B 2307/724; B32B 2437/00; B32B 5/26

(57) ABSTRACT

A recyclable laminate includes a first thin layer that includes a first inner surface, and a second thin layer that includes a second inner surface. The first inner surface is partially fusion bonded and partially unbonded to the second inner surface. No adhesive is provided between the first and second thin layers. The first thin layer and the second thin layer are made of a recyclable material, and are structurally different from each other. A recyclable garment made from the recyclable laminate is also disclosed.

### CROSS-REFERENCE TO RELATED APPLICATION

This application claims priority of Taiwanese Invention Patent Application No. 108139939, filed on Nov. 4, 2019.

### FIELD

The present disclosure relates to a recyclable laminate, and more particularly to a recyclable laminate made of recyclable material that can be melt-bonded to form a garment or a garment accessory.

### BACKGROUND

With advancement of textile technology, selection of raw materials for manufacturing textile products (e.g., garments) can be more diverse, so as to confer more functions to the textile products according to practical requirements. However, a recycling process of such garments is troublesome, and remains a problem to be solved. For example, in a process for manufacturing a garment made from a recyclable material such as polyethylene terephthalate (PET) bottles, the bottles, after being collected, are sorted according to colors, then subjected to disintegrating, cleaning, impurity removing, and dehydrating steps so as to be processed into cleaned polyester granules, followed by melt spinning and drawing to form yarns, which are subsequently made into fabrics and garments. When such garments, after being used, are recycled, the abovementioned steps of the manufacturing process are also required, and the previously encountered problems in the steps of sorting and impurity removing would be further amplified, requiring more steps for subsequent recycling process.

On the other hand, if a garment requires breathability and waterproofing functions or multiple accessories for holding things, a conventional method for manufacturing such garment includes bonding a breathable and waterproof microporous membrane layer to a fabric sheet using polyurethane reactive hot melt adhesives (PUR), which is also used for bonding garment accessories such as pockets, zippers, water sealing tapes, etc. to the garment. However, since PUR cannot be recycled, the discarded PUR would cause worrisome environmental pollution, in addition to the abovementioned problems of the recycling process.

### SUMMARY

Therefore, an object of the present disclosure is to provide a recyclable laminate that can alleviate at least one of the drawbacks of the prior art.

The recyclable laminate includes a first thin layer that includes a first inner surface, and a second thin layer that includes a second inner surface. The first inner surface is partially fusion bonded and partially unbonded to the second inner surface. The first thin layer and the second thin layer are made of a recyclable material, and are structurally different from each other.

Another object of the present disclosure is to provide a recyclable garment that can alleviate at least one of the drawbacks of the prior art.

The recyclable garment includes a first thin layer that includes a first inner surface, and a second thin layer that includes a second inner surface. The first inner surface is partially fusion bonded to the second inner surface in absence of an adhesive therebetween, and partially unbonded to the second inner surface. The first thin layer is a breathable waterproof thermoplastic microporous membrane, and the second thin layer is a woven fabric made of a thermoplastic material.

### BRIEF DESCRIPTION OF THE DRAWINGS

Other features and advantages of the present disclosure will become apparent in the following detailed description of the embodiments with reference to the accompanying drawings, of which:

FIG. 1 is a perspective view illustrating an embodiment of a recyclable laminate according to the present disclosure.

### DETAILED DESCRIPTION

Before the present disclosure is described in greater detail, it should be noted that where considered appropriate, reference numerals or terminal portions of reference numerals have been repeated among the FIGURES to indicate corresponding or analogous elements, which may optionally have similar characteristics.

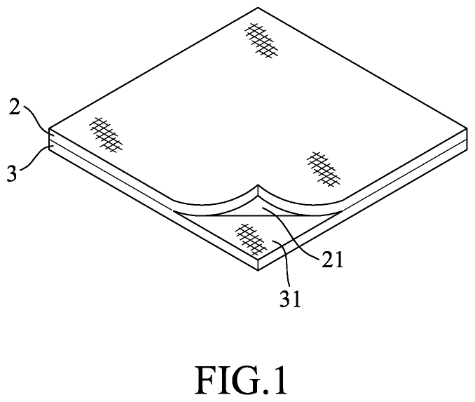

Referring to FIG. 1, a recyclable laminate according to an embodiment of the present disclosure includes a first thin layer 2 and the second thin layer 3 that is partially fusion-bonded to the first thin layer 2. The first thin layer 2 and the second thin layer 3 are made of a recyclable material such as a thermoplastic material, and are structurally different from each other. Examples of the thermoplastic material may include, but are not limited to, polyethylene terephthalate, polypropylene, thermoplastic polyurethane, polyethylene, and thermoplastic polyamide.

The thermoplastic materials used for making the first thin layer 2 and the second thin layer 3 may be of a similar type, so as to simplify process parameters of fusion bonding for producing a composite finished product or laminate and to enhance strength of fusion bonding, as well as to simplify recycling of the product or laminate and to improve purity of the recycled thermoplastic material, thereby facilitating and increasing the possibility of repeatedly recycling the thermoplastic materials.

The recyclable laminate of the present disclosure may be a combination of two or more fabric layers, or a combination of a membrane and one or more fabric layers. In certain embodiments, the first thin layer 2 is a membrane which has breathability and waterproof characteristics, and the second thin layer 3 is a fabric. In other embodiments of the recyclable laminate, the first thin layer 2 and the second thin layer 3 are fabrics made of thermoplastic materials of a similar type or different types.

When the first thin layer 2 and the second thin layer 3 are made of a similar type of the thermoplastic material, the first thin layer 2 and the second thin layer 3 may be directly connected to each other by partial fusion bonding without use of an adhesive therebetween.

Specifically, the first thin layer 2 includes a first inner surface 21, and the second thin layer 3 includes a second inner surface 31. The first inner surface 21 is directly melted and partially fusion-bonded to the second inner surface 31 in absence of an adhesive therebetween, and partially unbonded to the second inner surface 31. Examples of a method used for partial fusion bonding of the first inner surface 21 to the second inner surface 31 include, but are not limited to, hot pressing, hot air blowing, and high frequency bonding. However, when the first thin layer 2 and the second thin layer 3 are structurally and materially different from each other, the physical properties thereof, such as melting temperatures, will be different, and fusion bonding method such as high frequency bonding or ultrasonic bonding, cannot be utilized. Therefore, an adhesive is required to form the recyclable laminate. However, considering factors such as ease of recycling and repeatability for reuse, the adhesive to be used should be a thermoplastic adhesive that is of the same thermoplastic type as one of the first and second thin layers 2, 3 and that is made from a base material having the same thermoplastic type as one of the first thin layer 2 and the second thin layer 3, to which a hot-melt resin and an organic functional material are added.

The recyclable laminate of the present disclosure may be used for making various textile products. An example of the textile products is a recyclable garment which includes the first thin layer 2 and the second thin layer 3. The first thin layer 21 is a breathable waterproof thermoplastic microporous membrane, and the second thin layer 31 is a woven fabric made of the thermoplastic material. The first thin layer 2 includes the first inner surface 21, and the second thin layer 3 includes the second inner surface 31. The first inner surface 21 is partially fusion bonded to the second inner surface 31 in absence of an adhesive therebetween, and is partially unbonded to the second inner surface 31. The unbonded parts of the first and second inner surfaces 21, 31 separably contact each other. The bonded parts of the recyclable laminate of the present disclosure may be situated at peripheral parts of the first and second thin layers 2, 3, or at the inside of the peripheral parts. Other examples of textile products made from the recyclable laminate of the present disclosure may include garment accessories such as zippers, hook-and-loop fasteners, pockets, etc.

Examples of each of the first thin layer 2 and the second thin layer 3 may include, but are not limited to, a membrane, a non-woven fabric, a plain woven fabric, a knitted fabric, a fibrous sheet, a blended yarn fabric, a three-dimensional fabric, an embossed fabric, and a resinous sheet. In order to provide the recyclable laminate of the present disclosure with a lamination configuration, the first thin layer 2 and the second thin layer 3 fusion bonded together are structurally different from each other. In addition, suitable functional materials such as waterproof and/or warming materials may be added to the first thin layer 2 and the second thin layer 3, so that the thus made textile product is conferred with various different functions.

It should be noted that, the abovementioned recyclable garment and garment accessory are made from the recyclable laminate of the present disclosure that is fabricated by partially fusion bonding the first thin layer 2 and the second thin layer 3 without use of an adhesive. Therefore, if the first thin layer 2 and the second thin layer 3 are of the same type, the recyclable garments and garment accessories, after being collected, may be directly disintegrated, washed, and dehydrated without the need to undergo sorting, and then processed into a raw particulate material. If the first thin layer 2 and the second thin layer 3 are of different types, the recyclable garments and garment accessories, after being collected, will be first subjected to sorting of the first thin layer 2 and the second thin layer 3, followed by the abovementioned steps of the recycling process, indicating that such recycling process is greatly simplified compared to conventional recycling procedures.

In summary, by virtue of the first and second thin layers 2, 3 made of a recyclable thermoplastic material and partially fusion-bonded together without use of any adhesive such as polyurethane reactive hot melt adhesive (PUR), the resultant recyclable laminate of the present disclosure is suitable for subsequent recycling process to be reused, and thus, is environmentally friendly.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the present disclosure has been described in connection with what is considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A recyclable laminate, comprising:
a first thin layer including a first inner surface; and
a second thin layer including a second inner surface,
wherein said first inner surface is partially fusion-bonded and partially unbonded to said second inner surface, and
wherein said first thin layer and said second thin layer are made of a recyclable material, and are structurally different from each other.

2. The recyclable laminate as claimed in claim 1, wherein said first inner surface is partially fusion-bonded to said second inner surface in absence of an adhesive therebetween.

3. The recyclable laminate as claimed in claim 2, wherein each of said first thin layer and said second thin layer is selected from the group consisting of a membrane, a non-woven fabric, a plain woven fabric, a knitted fabric, a fibrous sheet, a blended yarn fabric, a three-dimensional fabric, an embossed fabric, and a resinous sheet.

4. The recyclable laminate as claimed in claim 2, wherein said first thin layer is a membrane, and said second thin layer is a fabric.

5. The recyclable laminate as claimed in claim 2, wherein each of said first thin layer and said second thin layer is a fabric.

6. The recyclable laminate as claimed in claim 1, wherein said first thin layer and said second thin layer are made of a thermoplastic material.

7. The recyclable laminate as claimed in claim 6, wherein said thermoplastic material is selected from the group consisting of polyethylene terephthalate, polypropylene, thermoplastic polyurethane, polyethylene, and thermoplastic polyamide.

8. The recyclable laminate as claimed in claim 6, wherein said first thin layer and said second thin layer constitute a garment, or a garment accessory.

9. The recyclable laminate as claimed in claim 1, wherein said first inner surface of said first thin layer and said second inner surface of said second thin layer are partially fusion-bonded by a method selected from the group consisting of hot pressing, hot air blowing, and high frequency bonding.

10. A recyclable garment, comprising:
a first thin layer including a first inner surface; and
a second thin layer including a second inner surface,
wherein said first inner surface is partially fusion-bonded to said second inner surface in absence of an adhesive therebetween, and partially unbonded to said second inner surface, and
wherein said first thin layer is a breathable waterproof thermoplastic microporous membrane, and said second thin layer is a woven fabric made of a thermoplastic material.
